(19) United States
(12) Patent Application Publication
(10) Pub. No.: US 2007/0081431 A1
(43) Pub. Date: Apr. 12, 2007

(54) Optical pickup

(75) Inventors: Yukio Watanabe, Uji-shi (JP); Tetsuo Ueyama, Nara-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 10/551,509

(22) PCT Filed: Mar. 23, 2004
(86) PCT No.: PCT/JP04/03984

§ 371 Date: Sep. 29, 2005

(30) Foreign Application Priority Data
Apr. 3, 2003 (JP) 2003-100742

(51) Int. Cl. G11B 7/00

(52) U.S. Cl. 369/44.12

(57) ABSTRACT

A grating (3) including first and second regions (B1 and B2) through which the light beams, having wavelengths λ1 and λ2, respectively, pass, each of the regions including a region having diffraction grooves whose concavoconvex pitches are partially shifted so that a pattern is provided to cause each of the first and second light beams to have a partial phase shift. The pattern is set so that amplitudes of push-pull signals of the sub-beams are substantially cancelled in each of the light beams having different wavelengths. With this, it is possible to provide an optical pickup (i) having a plurality having different light sources in one package, (ii) capable of realizing low cost in the case in which the optical pickup carries out track detection using three beams with respect to any optical discs, such as DVDs and CDs, and (iii) capable of realizing simplifications of assembly adjustment and the pickup.

### TECHNICAL FIELD

The present invention relates to an optical pickup that optically records and reproduces information to and from an information recording medium, such as an optical disc. Especially, the present invention relates to a tracking servo of the optical pickup having a plurality of light sources having different wavelengths, the tracking servo being capable of correcting an offset generated in tracking error signals easily and at low cost.

### BACKGROUND ART

In recent years, since optical discs can record a large amount of information signals with high density, they are used in many fields, such as audios, videos, computers etc.

In order to reproduce information signals recorded in the information recording medium (for example, the optical disc) in units of microns, it is necessary to have a light beam accurately track information tracks. Various methods have been known as a method for detecting a tracking error signal (TES) for the tracking.

Moreover, commercialized optical discs are exemplified by a disc using an infrared laser, such as CDs, and a disc using a red laser, such as DVDs. In addition, a high-density disc using a blue laser has been proposed recently. That is, since respective optical discs have different recording densities of information and disc structures, light beams having different wavelengths are used for recording and reproducing information to and from respective discs.

These days some optical disc apparatuses have an optical pickup which realizes recording and reproducing of both CDs and DVDs.

For example, as shown in FIG. 23, Japanese Unexamined Patent Publication No. 342956/2002 (Tokukai 2002-342956, published on Nov. 29, 2002) proposes an optical system which includes two-wavelength semiconductors laser in one package in order to miniaturize the optical pickup which can be used for both CDs and DVDS.

According to the above optical pickup, a single optical system carries out recording and reproduction of information to and from plural types of optical discs by the light beams (i) emitted from light sources 101a and 101b that are plural-wavelength semiconductor lasers provided in one package and (ii) having different wavelengths. Three-beam-use diffraction gratings 112 and 113 are provided on a light path. The light beams of wavelengths λ1 and λ2 pass through both the three-beam-use diffraction gratings 112 and 113. However, depth of grooves of the three-beam-use diffraction gratings 112 and 113 are set so that one three-beam-use diffraction grating functions with respect to only one of the light beams of the wavelengths λ1 and λ2. For example, in order to have the light beam of the wavelength λ1 function as three beams, the depth of the grooves is so set as to be an integral multiple of the wavelength λ2. With this, the diffraction grating does not generate diffracted light of the light beam of the wavelength λ1, and the light beam of the wavelength λ1 substantially passes through the diffraction grating.

According to a three-beams method, track detection is carried out by utilizing a difference in light intensity between +1^{st} order light and −1^{st} order light. Therefore, 0 order light, +1^{st} order light and −1^{st} order light need to be placed at predetermined positions on the optical disc. On this account, directions of the grooves of respective diffraction gratings need to be adjusted accurately when. assembling the optical pickup.

With the above arrangement, it is possible to satisfactorily record and reproduce information to and from different types of optical discs without deteriorating any one of light of the track detection.

Incidentally, as to the track detection using three beams, the present applicant has filed an application which describes a method (hereinafter referred to as “a phase shift DPP method”) for not requiring a rotational adjustment of the tree-beam-use diffraction grating during assembly. This application is disclosed as Japanese Unexamined Patent Publication No. 250250/2001 (Tokukai 2001-250250, published on Sep. 14, 2001).

The phase shift DPP method is a method for detecting tracks, and an improved version of a differential push pull method (DPP) which uses three beams. According to a general DPP method, an offset due to lens shifting is corrected in accordance with a difference between a push-pull signal of a main beam generated by the three-beam-use diffraction grating and push-pull signals of sub-beams generated by the three-beam-use diffraction grating.

In the case of a recordable disc, according to the three-beams method which compares intensities of reflected light of the sub-beams to find out the difference therebetween, an offset due to a change in intensities of reflected light is generated before and/or after recording, while according to the DPP method, an offset due to the same reason is small. Therefore, the DPP method is a better method in the case of carrying out recording to the optical disc. However, in order to cancel the offset component, the diffraction grating needs to be adjusted accurately so that positions, on the optical disc, of the main beam and the sub-beams generated by the three-beam-use diffraction grating are shifted by ½ pitch. Therefore, problems occur in the case of reproducing plural types of optical discs, having different track pitches, by a single optical pickup.

In order to solve the above problems, according to the phase shift DPP method, a groove pattern of the three-beam-use diffraction grating is formed so that two regions having different phases have substantially the same area in a region of the light beam contributing to the push-pull signals of the sub-beams. The following explains this method.

For example, as shown in FIG. 24(a), laser light emitted from a semiconductor laser 201 is converted into parallel light by a collimator lens 202, and the parallel light is split into a main beam 230, a sub-beam (+1^{st} order light) 231 and a sub-beam (−1^{st} order light) 232 by a grating 203. After those beams pass through a beam splitter 204, the beams are focused on a track 261 of an optical disc 206 by an objective lens 205. Reflected light pass through the objective lens, and then are reflected by the beam splitter 204. Then, a condenser lens 207 guides the light to a photodetector 208 (208A, 208B and 208C).

As shown in FIG. 25, far field patterns of the reflected light of the main beam 30, the sub-beam (+1^{st} order light) 31 and the sub-beam (−1^{st} order light) 32 are received by two-part photodetectors 208A, 208B and 208C, which respectively have dividing lines corresponding to a track direction. The two-part photodetectors 208A, 208B and 208C produce push-pull signals PP230, PP231 and PP232, respectively, which are differential signals.

Here, as shown in FIG. 24(a), an X-Y coordinate system is set up. The center of the beam is an origin, the radial direction of the optical disc is an x direction, and the track direction orthogonal to the radial direction is a y direction. As shown in FIG. 24(b), in the case in which the phase of a periodic structure of the track grooves in the first quadrant on the grating 203 is 180-degree out of phase from that of other quadrants, the sub-beams 231 and 232 diffracted by the grating 206 have a 180-degree phase difference only in the first quadrant. In this case, as shown in FIG. 26(a), the amplitudes of the push-pull signals PP231 and PP232 of the sub-beams 231 and 232 become substantially 0 as compared with the push-pull signal PP230 of the main beam that does not have the phase difference. This is because no push-pull signal is detected regardless of the position of the track and the signals are substantially the same regardless of whether the sub-beams 231 and 232 fall on the same track as the main beam 230, or on a different track.

In contrast, as shown in FIG. 26(b), as to an offset of a tracking error signal (TES) by objective lens shifting or disc tilting, the push-pull signal PP230 and the push-pull signal PP231 (or the push-pull signal PP232) generate offsets Δp and Δp′ on the same side (in-phase) in accordance with their respective light intensities. Therefore, by solving the following equation it is possible to detect a differential push-pull signal PP234 which has cancelled the above offsets.

$$\begin{matrix}PP 234 = PP 230 - k ( PP 231 + PP 232 ) \\ = PP 230 - k \cdot PP 233\end{matrix}$$

In the equation, the coefficient k is for correcting a difference in the light intensity between the 0 order light main beam 230 and the +1^{st} order light sub-beam 231, and between the 0 order light main beam. 230 and the −1^{st} order light sub-beam 232. When the intensity ratio of the 0 order light main beam 230 : +1^{st} order light sub-beam 231 :−1^{st} order light sub-beam 232=a:b:b, the coefficient k=a/(2b). Moreover, the push-pull signal PP233 is the sum of the push-pull signal PP231 of the sub-beam 231 and the push-pull signal PP232 of the sub-beam 232.

According to tracking error detection using the phase shift DPP method, the amplitude of push-pull signal PP233 of the sub-beams 231 and 232 become 0 regardless of the depth of the groove. That is, since the amplitude is 0 wherever on a track the three beams locate, positional adjustments (rotational adjustment of the diffraction grating, etc.) of the three beams becomes unnecessary. Therefore, it is possible to drastically simplify assembly adjustment of the pickup.

Moreover, in the case of using a hologram laser unit, and especially in the case of placing a phase shift diffraction grating near a semiconductor laser light source, an actual region through which the sub-beams pass is shifted from a region through which the main beam pass on the diffraction grating. This causes a problem in that the two sub-beams cannot have a common optimum phase shift. A phase shift pattern perfect for depth and pitch of a certain optical disc is proposed in the above Japanese Unexamined Patent Publication No. 250250/2001.

However, as with the method disclosed in the above Japanese Unexamined Patent Publication No. 250250/2001, in the case in which the optical pickup having a plurality of light sources detects tracks of DVDs and CDs by using the three-beams method, it is necessary to adjust respective gratings so that the gratings are perfect for pitches of respective optical discs. On this account, this method cannot realize lower cost, simplification and miniaturization of the optical pickup.

Moreover, in a method using the phase shift grating shown in the above Japanese Unexamined Patent Publication No. 250250/2001, a region causing the phase shift is a phase shift pattern which is optimally set with respect to the light beam of a single light source. On this account, as to the optical pickup having a plurality of light sources, the push-pull signals of one of the sub-beams are not cancelled adequately in the case in which one phase shift grating is used for a plurality of light beams having different numerical apertures, and in the case in which the position of the beam on the grating changes depending on the wavelength. Therefore, there is the problem in that the characteristics of the track detection deteriorate.

The present invention was made to solve the above problems, and an object of the present invention is to provide an optical pickup which (i) has a plurality of light sources in one package, (ii). can carry out a track detection at low cost, the track detection using three beams with respect to any optical discs, such as DVDs and CDs, and (iii) can realize simplifications of the assembly adjustment and the pickup.

### DISCLOSURE OF INVENTION

In order to achieve the above object, an optical pickup of the present invention which carries out tracking by three beams with respect to an optical disc includes: a one-packaged light source for emitting a light beam having a first wavelength and a light beam having a second wavelength; a grating for splitting a light beam, emitted from the one-packaged light source, into a main beam and two sub-beams; an objective lens for focusing the main beam and the sub-beams on the optical disc; and a photodetector for detecting push-pull signals from respective light of the main beam and the sub-beams, reflected by the optical disc. The grating includes first and second regions through which the light beams, having the first and second wavelengths, respectively, pass, each of the regions including a region having diffraction grooves whose concavoconvex pitches are partially shifted so that a pattern is provided to cause each of the first and second light beams to have a partial phase shift, and the pattern is set so that amplitudes of the push-pull signals of the sub-beams are substantially cancelled in each of the light beams having different wavelengths.

According to the above invention, the grating includes first and second regions through which the light beams, having the first and second wavelengths, respectively, pass, each of the regions including a region having diffraction grooves whose concavoconvex pitches are partially shifted so that a pattern is provided to cause each of the first and second light beams to have a partial phase shift. Moreover, the pattern is set so that the amplitudes of the push-pull signals of the sub-beams are substantially cancelled in each of the light beams having different wavelengths.

That is, in the present invention, the pattern causing the phase shift which pattern is so set that the amplitudes of the push-pull signals of the sub-beams are substantially cancelled includes a region, in each region through which each light beam pass, where the convexconcave pitches of the diffraction grooves are shifted from the pitches of other region(s) of the pattern. With this, the pattern can be set so that, in the case of irradiating the light beam having the first wavelength, the amplitudes of the push-pull signals of the sub-beams are substantially cancelled only in the region through which the light beam having the first wavelength pass. Moreover, the pattern can be set so that, in the case of irradiating the light beam having the second wavelength, the amplitudes of the push-pull signals of the sub-beams are substantially cancelled only in the region through which the light beam having the second wavelength pass. In fact, the pattern is set in this manner.

Therefore, the track detection using the three-beams method can be carried out by using a single common grating with respect to the light beams having different wavelengths, and the offset component due to the lens shifting, etc. can be cancelled easily.

As a result, it is possible to provide an optical pickup which (i) has a plurality of light sources in one package, (ii) can carry out a track detection at low cost, the track detection using three beams with respect to any optical discs, such as DVDs and CDs, and (iii) can realize simplifications of the assembly adjustment and the pickup.

Additional objects, features, and strengths of the present invention -will be made clear by the description below. Further, the advantages of the present invention will be evident from the following explanation in reference to the drawings.

### BRIEF DESCRIPTION OF DRAWINGS

FIG. 1(a) shows one embodiment of a pickup apparatus of the present invention, and is a plan view showing an arrangement of a grating on which a phase shift pattern is formed. FIG. 1(b) is an enlarged plan view of a region in a dot circle shown in FIG. 1(a).

FIG. 2(a) is a diagram showing a schematic arrangement of an optical system of the pickup apparatus, and shows a case in which a two-wavelength semiconductor laser 1a outputs a light beam having a wavelength λ2. FIG. 2(b) is a diagram showing a schematic arrangement of the optical system of the pickup apparatus, and shows a case in which a two-wavelength semiconductor apparatus 1b outputs a light beam having a wavelength λ1.

FIG. 3 is a plan view showing diameters of the light beams of wavelengths λ1 and λ2, the light beams having passed through an aperture control device of the pickup apparatus.

FIG. 4(a) is a cross sectional diagram showing a diffraction pattern of reflected beams of sub-beams of the pickup apparatus, the reflected beams being reflected by the optical disc. FIG. 4(b) is a plan view showing the a diffraction pattern, on an objective lens, of the reflected beams of the sub-beams, the reflected beams being reflected by the optical disc.

FIGS. 5(a) and 5(b) are plan views showing push-pull patterns, on the objective lens, of the reflected beams of the sub-beams, the reflected beams being reflected by the optical disc.

FIG. 6 is a plane view showing an arrangement of a grating on which another phase shift pattern is formed.

FIG. 7 is a plane view showing a push-pull pattern, on the objective lens, of the reflected beams of the sub-beams generated by the above grating, the reflected beam being reflected by the optical disc.

FIG. 8 is a plane view showing an arrangement of a grating on which yet another phase shift pattern is formed.

FIGS. 9(a) and 9(b) are plane views showing push-pull patterns, on the objective lens, of the reflected beams of the sub-beams generated by the above grating, the reflected beams being reflected by the optical disc.

FIG. 10 is a plan view showing an arrangement of a grating on which still another phase shift pattern is formed.

FIG. 11 is a plan view showing a push-pull pattern, on the objective lens, of the reflected beams of the sub-beams, the reflected beams being reflected by the optical disc.

FIG. 12 shows another embodiment of a pickup apparatus of the present invention, and is a diagram showing a schematic arrangement of an optical system.

FIG. 13 is a plan view showing structures of a hologram element and a light receiving element in the above pickup apparatus.

FIG. 14 is a cross sectional diagram showing a schematic arrangement of a pickup apparatus in which the hologram element and the light receiving element are integrated.

FIG. 15 is a plan view showing a beam diameter of the light beam having the wavelength λ1 and a beam diameter of the light beam having the wavelength λ2, the beam diameters being on the grating of the pickup apparatus.

FIG. 16 is a plan view showing an arrangement of a grating on which a phase shift pattern is formed, the grating being in the above pickup apparatus.

FIG. 17 is a plan view showing positions, on the hologram element, of the main beam and the sub-beams which pass through the hologram element of the above integrated pickup apparatus.

FIG. 18 shows yet another embodiment of a pickup apparatus of the present invention, and is a plan view showing a phase shift pattern of a three-beam-use diffraction grating.

FIG. 19 is a plan view showing a push-pull pattern of the sub-beams in the case of using the three-beam-use diffraction grating.

FIG. 20 is a plan view showing another phase shift pattern in the case of using the three-beam-use diffraction grating.

FIG. 21 is a plan view showing yet another phase shift pattern in the case of using the three-beam-use diffraction grating.

FIG. 22 is a plan view showing still another phase shift pattern in the case of using the three-beam-use diffraction grating.

FIG. 23 is a diagram showing a schematic arrangement of a conventional pickup apparatus.

FIG. 24(a) is a diagram showing a schematic arrangement of another conventional pickup apparatus, and FIG. 24(b) is a plan view showing a grating of the above pickup apparatus.

FIG. 25 is a block diagram showing a principle for detecting push-pull signals of the above pickup apparatus.

FIG. 26(a) is a waveform chart showing waveforms of the push-pull signals of the main beam and the sub-beams in the above pickup apparatus, and FIG. 26(b) is a waveform chart showing waveforms of the push-pull signals in the case in which the objective lens is shifted in the above pickup apparatus.

### BEST MODE FOR CARRYING OUT THE INVENTION

The following explains the present invention in more detail with embodiments and comparative examples, however the present invention is not limited to these.

(Embodiment 1)

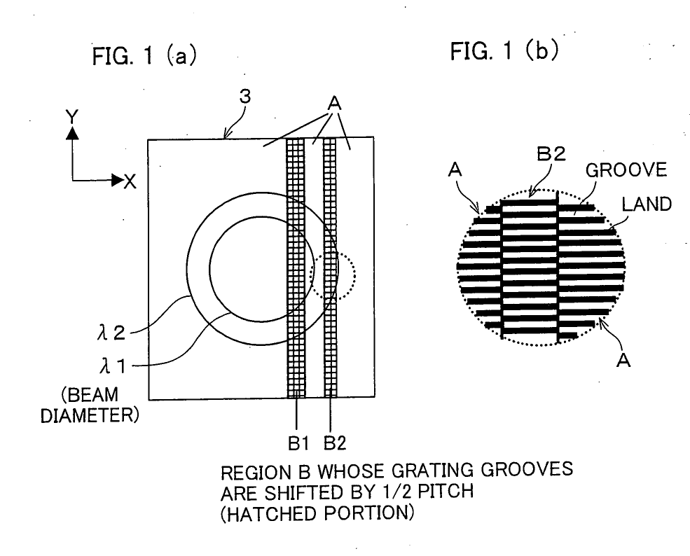

The following explains one embodiment of the present invention in reference to FIGS. 1 to 11.

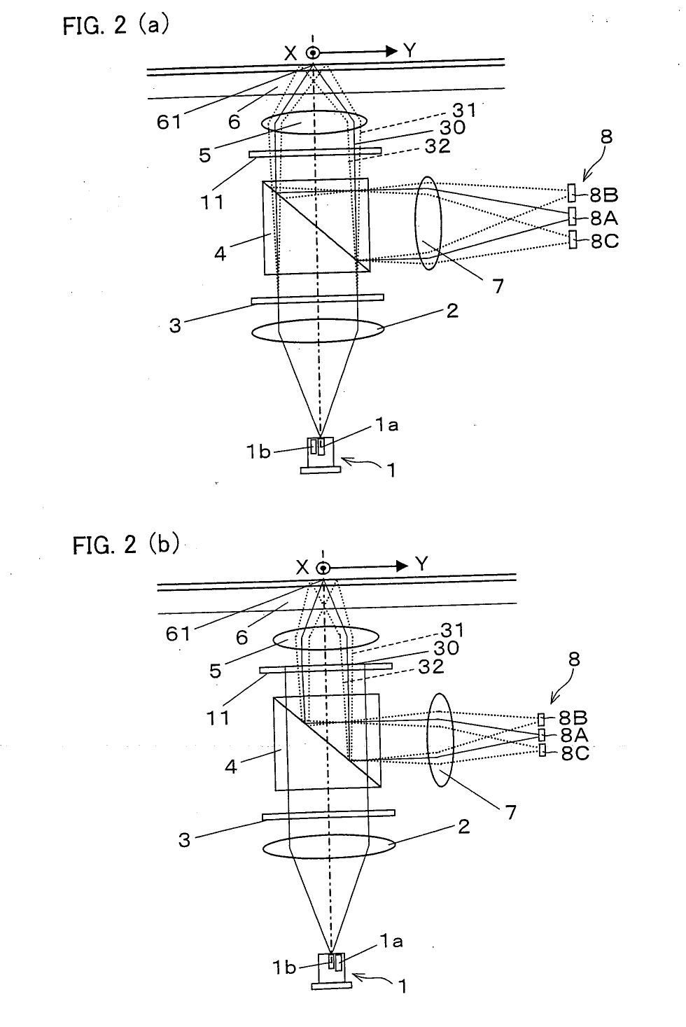

As shown in FIGS. 2(a) and 2(b), a pickup apparatus as an optical pickup of the present embodiment includes: a one-packaged light source 1 that emits two types of light beams, that is, a light beam having a wavelength λ1 as a first wavelength and a light beam having a wavelength λ2 as a second wavelength; a grating 3 as a grating that splits each light beam, emitted from the light source 1, into a main beam and two sub-beams; an objective lens 5 that focuses those three beams on an optical disc 6; and a photodetector 8 that detects push-pull signals from respective reflected light of the three beams. The pickup apparatus carries out tracking by using the three beams.

The light source 1 includes two-wavelength semiconductor lasers 1a and 1b. The two-wavelength semiconductor laser 1a outputs the light beam having the wavelength λ2, while the two-wavelength semiconductor laser 1b outputs the light beam having the wavelength λ1. Note that the wavelengths λ1 and λ2 are different from each other. The grating 3 is a transparent diffraction grating, and grooves are formed on the surface of the grating 3, in other words, the surface has convexconcave. Further, the photodetector 8 includes three two-part photodetectors 8A, 8B and 8C in order to detect the push-pull signals from respective reflected light of the three beams.

In the pickup apparatus, the light beams of the wavelengths λ2 and λ1, emitted from the two-wavelength semiconductor lasers 1a and 1b, are converted into parallel light by a collimator lens 2. Then, the grating 3 splits the parallel light into a main beam 30, a sub-beam (+1^{st} order light) 31 and a sub-beam (−1^{st} order light) 32.

Next, the beams having passed through a beam splitter 4 pass through an aperture control device 11 provided before the objective lens 5, and then are focused on a track 61 of the optical disc 6. As shown in FIG. 2(b), a region through which the light beam having the wavelength λ1 pass, emitted from the two-wavelength semiconductor laser 1b, is narrowed down by the aperture control device Next, the reflected light from the optical disc 6 pass through the objective lens 5, and then are reflected by the beam splitter 4. Then, a condenser lens 7 guides the light to the photodetector 8. Far field patterns of the reflected light of the main beam 30, the sub-beam (+1^{st} order light) 31 and the sub-beam (−1^{st} order light) 32 are received by the two-part photodetectors 8A, 8B, and 8C, which respectively have dividing lines corresponding to a track direction. The two-part photodetectors 8A, 8B, and 8C produce push-pull signals PP30, PP31 and PP32, respectively, which are differential signals.

The aperture control device 11 is a device for obtaining a predetermined numerical aperture defined by each optical disc 6, and an outer periphery of the region through which the light beam passes has a function as a wavelength-selective transmission filter which does not allow the light beam having the wavelength λ1, used for CDs, to pass therethrough but allows the light beam having the wavelength λ2, used for DVDs, to pass therethrough.

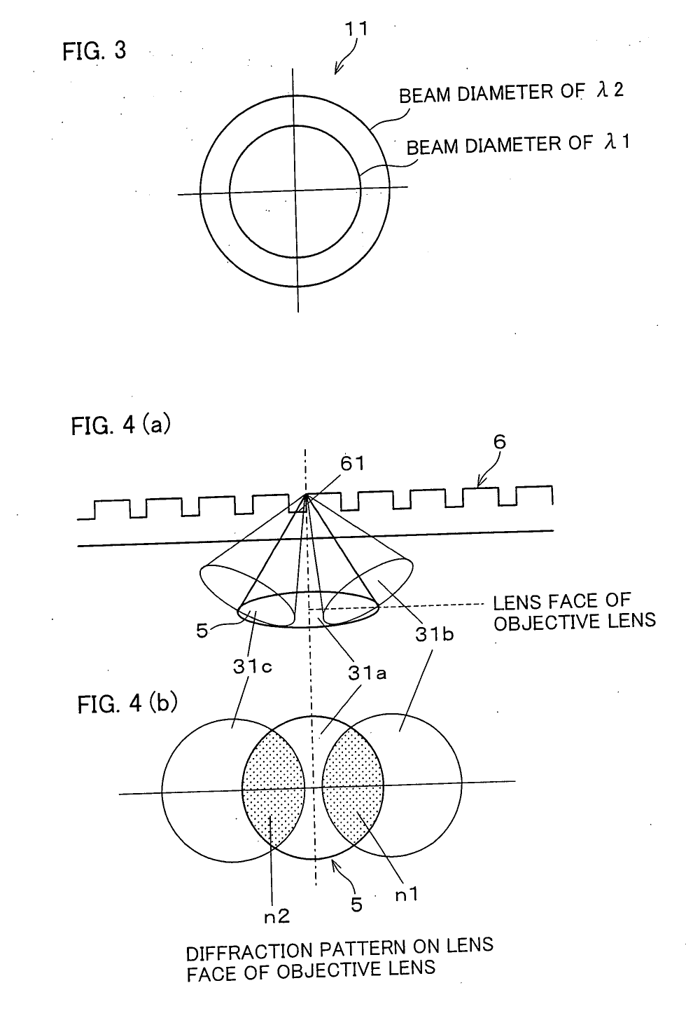

Therefore, an inner circle and an outer circle shown in FIG. 3 are a beam diameter of the light beam having the wavelength λ1 and a beam diameter of the light beam having the wavelength λ2, respectively, the beams having passed through the aperture control device 11.

Here, a structure of the grooves of the grating 3 that is the diffraction grating that generates three beams has characteristics in the present embodiment. The following explains the characteristics in reference to FIGS. 1(a) and 1(b).

First, the present embodiment adopts a method (hereinafter referred to as “the phase shift DPP method”) for not requiring, during assembly, the rotational adjustment of the grating 3 that is the three-beam-use diffraction grating.

The phase shift DPP method is a method for detecting tracks, and an improved version of a differential push pull method (DPP) which uses three beams. According to a general DPP method, an offset due to lens shifting is corrected in accordance with a difference between the push-pull signal of the main beam generated by the three-beam-use diffraction grating and the push-pull signals of the sub-beams 31 and 32 generated by the three-beam-use diffraction grating. Specifically, the correction is carried out so that an offset component is cancelled.

However, in the common DPP method, in order to cancel the offset component, the diffraction grating needs to be adjusted accurately so that positions, on the optical disc, of the main beam and the sub-beams generated by the three-beam-use diffraction grating are shifted by ½ pitch. Therefore, problems occur in the case in which plural types of optical discs having different track pitches are reproduced by a single optical pickup.

In order to solve the problems, according to the phase shift DPP method, a groove pattern of the three-beam-use diffraction grating is formed so that two regions having different phases have substantially the same area in a region of the light beam contributing to the push-pull signals of the sub-beams.

However, according to a conventional phase shift DPP method, a region causing a phase shift is a phase shift pattern which is optimally set with respect to the light beam of a single light source. On this account, as to the optical pickup having a plurality of light sources, the push-pull signals of one of the sub-beams are not cancelled adequately in the case in which one phase shift grating is used for a plurality of light beams having different numerical apertures, and in the case in which the position of the beam on the grating changes depending on the wavelength. Therefore, there is the problem in that the characteristics of the track detection deteriorate.

Here, the pickup apparatus of the present embodiment adopts the following arrangement.

First, as shown in FIG. 1(a), an X-Y coordinate system is set up in the grating 3. The center of a region through which a light beam passes is the origin, a radial direction which corresponds to the radial direction of an optical disc is the x direction, and the track direction is the y direction. Here, regions A that are first grating patterns and regions B that are second grating patterns different from the first grating patterns are formed in a region on the right side of the y axis, and the regions A and the regions B are parallel to the y axis.

As shown in FIG. 1(b), depression/projection grooves of the grating 3 are formed perpendicular to the track direction (the y-axis direction) in the regions A that are the first grating patterns. Meanwhile, the pitches of depression/projection grooves of the grating 3 in the regions B that are the second grating patterns are the same as those in the regions A, however grating grooves in the regions B are shifted from those in the regions A by ½ pitch. That is, lands (projections) and grooves (depressions) are inverted between the regions A and the regions B. With this arrangement, there is a phase difference of 180 degrees between the regions A and the regions B. Therefore, assuming that the regions A have no phase difference, the regions B have a phase difference of 180 degrees.

In the present embodiment, a region B1 having the second grating pattern is formed on a region through which the light beams of the wavelengths λ1 and λ2 pass, and a region B2 having the second grating pattern is formed on a region through which only the light beam having the wavelength λ2 passes.

As shown in FIG. 2(a) and 2(b), the light beam is split into the main beam 30 and the sub-beams 31 and 32 by the grating 3, and then those beams pass through the aperture control device 11. Here, as to the beam diameters of the light beams of the wavelengths λ1 and λ2 shown in FIG. 3, on the grating 3, an area of the region B in the region through which the light beam having the wavelength λ1 passes and an area of the region B in the region through which the light beam having the wavelength λ2 passes are different from each other. Therefore, spots of the sub-beams 31 and 32 focused on the optical disc 6 by the objective lens 5 are different in form between the light beam having the wavelength λ1 and the light beams of the wavelength λ2. Moreover, a diffraction angel changes depending on the wavelength, and the distance between the spot of the sub-beam 31 or 32 and the spot of the main beam 30 of the light beam having the wavelength λ1 is longer than the distance between the spot of the sub-beam 31 or 32 and the spot of the main beam 30 of the light beam having the wavelength λ2.

Here, the amplitudes of the push-pull signals PP31 and PP32 of the sub-beams 31 and 32 become substantially 0 as compared with the amplitude of the push-pull signal PP30 of the main beam 30 that does not have a phase difference.

The following explains a principle in which the push-pull signals PP31 and PP32 of the sub-beams 31 and 32 are not generated, that is, the amplitudes of the push-pull signals are 0.

As shown in FIG. 4, the light beam, for example, the sub beam 31 focused on the track 61, having the periodic structure, with the objective lens 5 is reflected and divided into 0 order diffraction light 31a and +1^{st} order diffraction light 31b and 31c. These diffraction light interfere in overlapping regions n1 and n2, and form a diffraction pattern (push-pull pattern) on a lens face of the objective lens 5.

In the case of using the grating 3 of the present embodiment, due to the region B1 that has the phase difference shown in FIG. 1(b), the reflected diffraction light have a phase shift of 180 degrees at a portion corresponding to the hatched portion of the grating 3, as compared with the non-hatched portions.

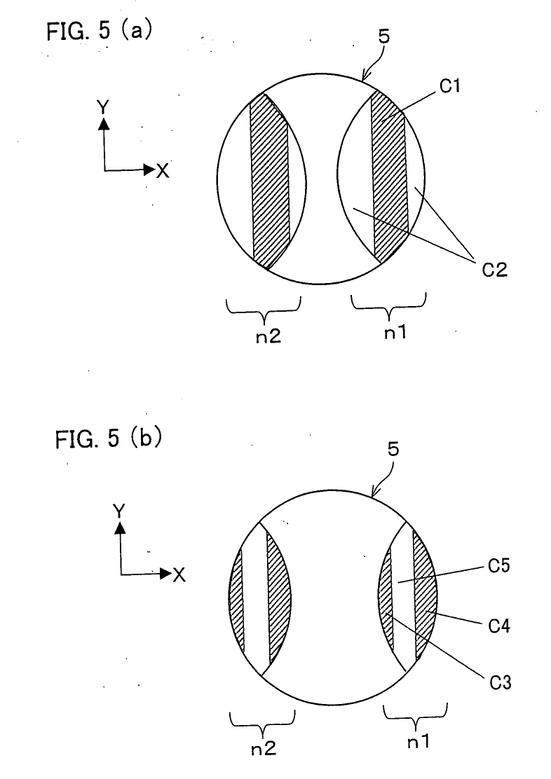

Therefore, for example, in the case in which the light beam having the wavelength λ1 and smaller beam diameter is reflected by the optical disc 6 and then incident on the objective lens 5, in a region where the diffraction light overlap, that is, in a push-pull signal region n1 that is a region which becomes either light or dark by the off-track of the light beam, the phase of the amplitude of the push-pull. signal in a region (hatched portion in FIG. 5(a)) C1 where a portion having the phase shift, of the 0 order light having passed through the region BI and a portion of the 1^{st} order diffraction ray having passed through the region A overlap is exactly opposite to the phase of the amplitude of the push-pull signal in non-hatched portions C2, as shown in FIG. 5(a).

Here, the region B1 is set so that the region having the phase of the amplitude of the push-pull signal different from the phase of other region(s) is substantially half in area of the push-pull signal region n1. With this, in the case of focusing on the push-pull signal region n1, the regions of light and dark are always substantially equal in area regardless of a state of the off-track. No push-pull component is detected in the end in the case in which the region Cl and the region C2 are added.

Meanwhile, in the case in which the light beam having the wavelength λ2 and larger beam diameter is reflected by the optical disc 6 and then incident on the objective lens 5, two separate regions having the phase difference of 180 degrees are formed in the push-pull signal region n1, as shown in FIG. 5(b). Here, the region B2 is set so that the sum (the sum of the hatched portions) of areas of a portion C3 and a portion C4 is substantially equal to the area of a region C5. With this, as with the light beam having the wavelength λ1 and smaller beam diameter, the regions of light and dark are always substantially equal in area regardless of the state of the off-track. No push-pull component is detected in the end.

Moreover, in the case in which a track pitch, etc. of the optical disc 6 is changed, the push-pull pattern changes. In this case, the region B2 is appropriately set in a region, where on the grating 3 only the light beam having the wavelength λ2 passes through, in accordance with the change in the push-pull pattern due to the change of the pitch. In this way, it is possible to add the phase difference which cannot be given by the region B1.

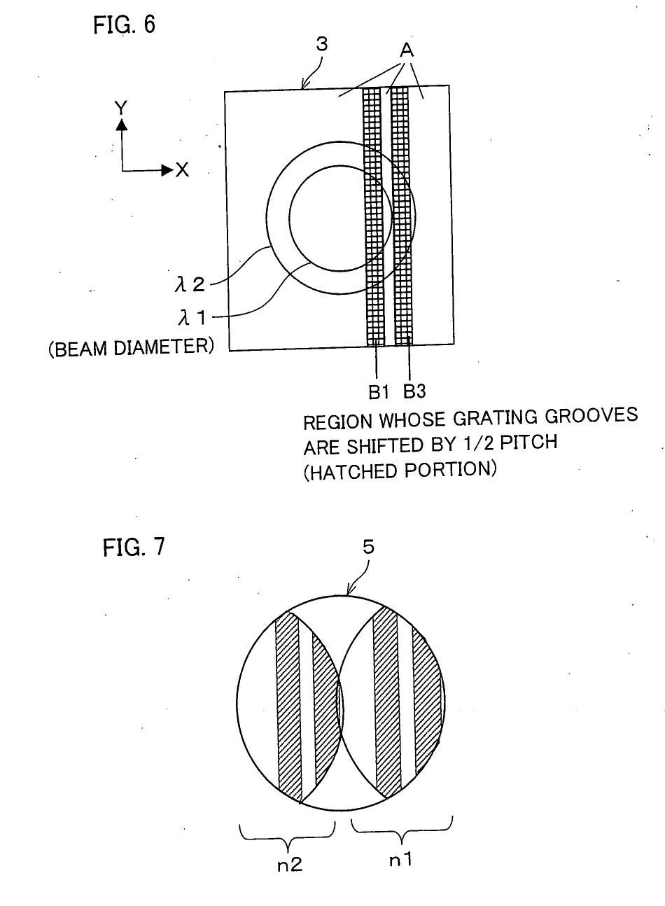

In the case of the optical disc 6 having wide track pitches, the region B2 on the grating 3 is so set as to be a region B3 shown in FIG. 6.

In this case, the push-pull pattern on the objective lens 5 is shown in FIG. 7. In the push-pull signal region n1, the region (the hatched portion) where the phase difference is added and the region (the non-hatched portion) where the phase difference is not added are substantially equal in area. Thus, the amplitude of the push-pull signal becomes substantially 0.

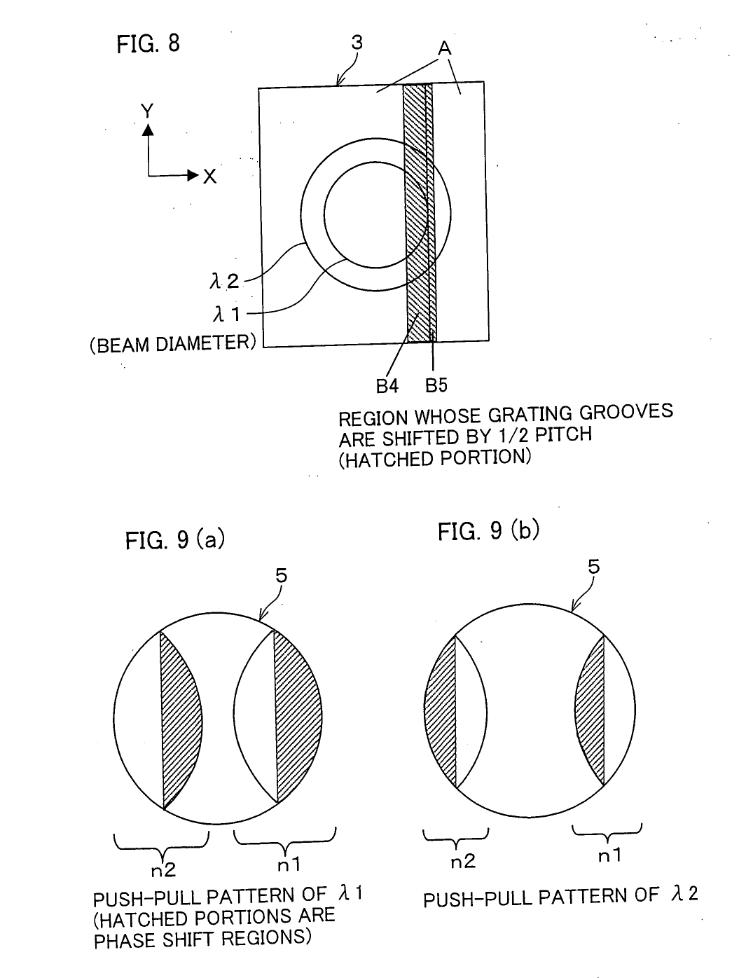

Moreover, the regions causing the phase shift can be adjacent to each other on the grating 3 as shown in FIG. 8. In this case, a region B4 causing the phase shift is formed on a region where both of the light beams of the wavelengths λ1 and λ2 pass through, and a region BS causing the phase shift is formed on a region where only the light beam having the wavelength λ2 passes through.

Therefore, the grating 3 includes two regions A of no phase shift and one region B causing the phase shift.

In this case, as shown in FIGS. 9(a) and 9(b), in each of the push-pull signal regions n1 and n2 of the light beams of the wavelengths λ1 and λ2, the hatched region where the phase is added and the non-hatched region where the phase is not added are substantially equal in area. Thus, the amplitude of the push-pull signal becomes substantially 0.

Note that the present embodiment explains a case in which the region(s) causing the phase shift is formed on the right side of the y axis on the grating 3. However, the present embodiment is not limited to this, and the same effects can be obtained also in the case in which the regions causing the phase shift are formed on both sides of the y axis in a symmetrical manner about the y axis.

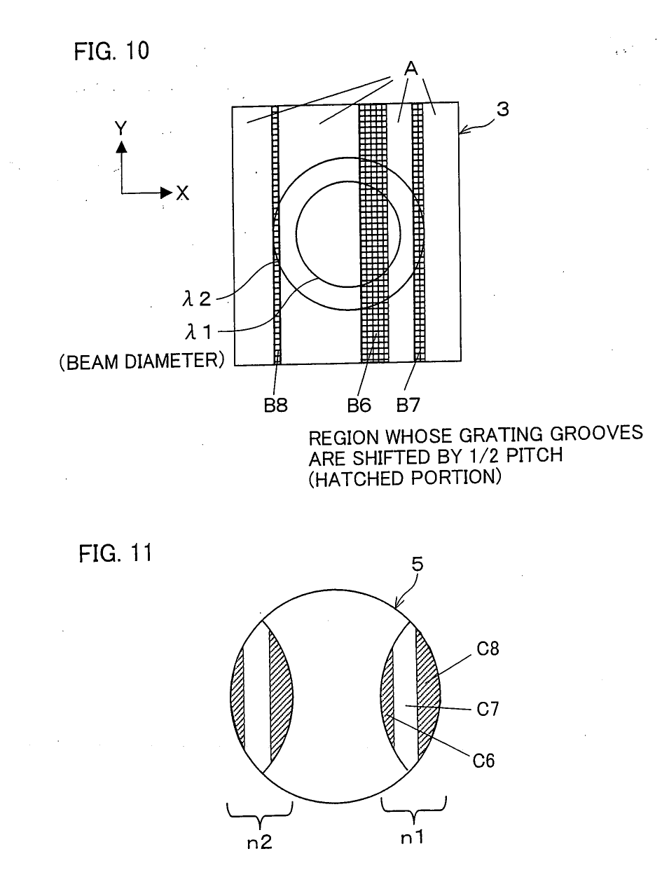

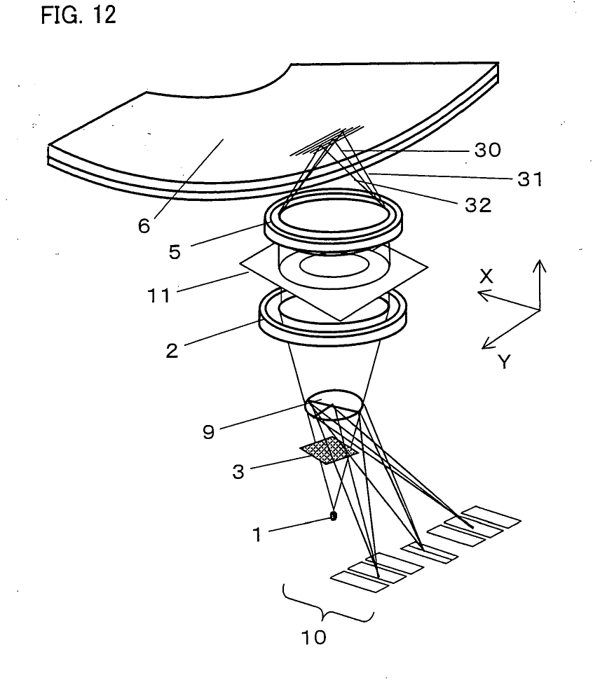

Moreover, as shown in FIG. 10, the phase shift regions on the grating 3 can be formed on both sides of the y axis. In this case, the push-pull pattern of the light beam having the wavelength λ2 is shown in FIG. 11. Here, regions C6 and C8 in the push-pull signal region n1 are obtained by the phase shift of the +1^{st} order diffraction ray and 0 order diffraction ray of the sub-beams 31 and 32. Again, the hatched portion and the non-hatched portion are substantially equal in area.

According to the present embodiment, the amplitudes of the push-pull signals PP31 and PP32 of the sub-beams 31 and 32 becomes 0 regardless of the light having different numerical apertures. That is, the amplitudes of the push-pull signals of the sub-beams 31 and 32 are always 0 with respect to the light beam having the wavelength λ1 and the light beam having the wavelength λ2. Therefore, it is unnecessary to adjust positions of three beams. On this account, only one three-beams-use diffraction grating is enough, so that it is possible to reduce the cost of the pickup apparatus and simplify the pickup apparatus.

Thus, in the pickup apparatus of the present embodiment, the grating 3 has thereon a pattern causing the partial phase shift with respect to the light beams of the wavelengths λ1 and λ2, the pattern including the region B (i) being formed in each of the regions, contributing the tracking signal detection, through which regions the light beams having the wavelengths λ1 and λ2 pass, and (ii) having the convexconcave pitches of the diffraction grooves, the pitches being shifted from the pitches of other region(s) of the pattern. Moreover, the pattern causing the phase shift is set so that the amplitudes of the push-pull signals of the sub-beams of the light beams having different wavelengths are substantially cancelled.

That is, in the present embodiment, the pattern causing the phase shift which pattern is so set that the amplitudes of the push-pull signals of the sub-beams 31 and 32 of the light beams having different wavelengths are substantially cancelled includes a region, in each region through which each light beam passes, where the convexconcave pitches of the diffraction grooves are shifted from the pitches of other region(s) of the pattern. With this, the pattern can be set so that, in the case of irradiating the light beam having the wavelength λ1, the amplitudes of the push-pull signals of the sub-beams 31 and 32 are substantially cancelled only in the region through which the light beam having the wavelength λ1 passes. Moreover, the pattern can be set so that, in the case of irradiating the light beam having the wavelength λ2, the amplitudes of the push-pull signals of the sub-beams 31 and 32 are substantially cancelled only in the region of the light beam having the wavelength λ2. In fact, the pattern is set in this manner.

Therefore, the track detection using three beams can be carried out by using a single common grating with respect to the light beams having different wavelengths, and the offset component due to the lens shifting, etc can be cancelled easily.

As a result, it is possible to provide an optical pickup which (i) has a plurality of light sources in one package, (ii) can carry out the track detection at low cost, the track detection using three beams with respect to any optical discs, such as DVDs and CDs, and (iii) can realize simplifications of the assembly adjustment and the pickup.

Moreover, on the pickup apparatus of the present embodiment, (i) the pattern causing the partial phase shift includes a first phase shift pattern and a second phase shift pattern which are formed substantially parallel to a track, (ii) the first phase shift pattern is provided so as to include part of the first region and part of the second region, both the first and second regions contributing to the tracking signal detection, and (iii) the second phase shift pattern is provided so as to include only part of the second region.

That is, in the case in which, on the grating, the first region through which the light beam having the wavelength λ1 pass is inside the second region through which the light beam having the wavelength λ2 pass, the pattern causing the phase shift is formed in the same way as above.

As a result, in the track detection by using the phase shift DPP method and the pickup apparatus in which a plurality of two-wavelength semiconductor lasers (1a, 1b) having different wavelengths are integrated in one package, it is possible to surely suppress the amplitudes of the push-pull signals of the sub-beams even in the case in which the numerical aperture changes due to the wavelength or in the case in which the light beams having different standards are used.

Moreover, in the pickup apparatus of the present embodiment, a pattern causing the light beam having the wavelength λ1 to have the phase shift and a pattern causing the light beam having the wavelength λ2 to have the phase shift are formed on one side of a boundary which passes through centers of the light beams passing through the grating and is substantially parallel to a track direction of the optical disc 6.

Because the patterns causing the light beams of the wavelengths λ1 and λ2 to have the phase shift are formed on one side of the grating 3, it is possible to simplify the assembling process and reduce the cost of the optical pickup.

Moreover, the pickup apparatus of the present embodiment can be arranged as follows: the pattern causing the light beam having the wavelength λ1 to have the phase shift is formed on one side of a boundary which passes through the centers of the light beams passing through the grating and is substantially parallel to the track direction of the optical disc 6, while the pattern causing the light beam having the wavelength λ2 to have the phase shift is formed on both sides of the boundary which passes through the centers of the light beams passing through the grating and is substantially parallel to the track direction of the optical disc.

Therefore, for example, in the case of using the optical disc 6 having wide track pitches or in the case in which the regions, contributing to the tracking signal detection, through which regions the light beams of the wavelengths λ1 and λ2 pass substantially overlap, the pattern causing the phase shift is formed, as explained in the present embodiment. In this way, it is possible to surely suppress the amplitudes of the push-pull signals of the sub-beams.

(Embodiment 2)

The following explains another embodiment of the present invention in reference to FIGS. 12 to 17. Note that the members other than the members described in the present embodiment are the same with the members described in Embodiment 1. Therefore, for ease of explanation, the same reference numerals are used for the members having the same functions as the members shown in the figures of Embodiment 1, and further explanations thereof are omitted.

The following explains a case in which a pickup apparatus as an optical pickup of the present embodiment. includes a hologram laser unit integrating (i) the two-wavelength semiconductor lasers 1a and 1b provided in one package as the light source, (ii) the grating 3 as the three-beam-use grating, (iii) a beam deflection hologram for generating a servo signal and (iv) the photodetector.

As shown in FIG. 12, the light beam having emitted from the light source 1 including the two-wavelength semiconductor lasers 1a and 1b is split by the grating 3 into three beams, that is, a 0 order main beam 30, +1^{st} order sub-beam 31 and −1^{st} order sub-beam 32. A 0 order diffraction ray of the hologram element 9 is focused on the optical disc 6 through the collimator lens 2, the aperture control device 11 and the objective lens 5. Then, a returning ray of the 0 order diffraction ray is diffracted by the hologram element 9, and guided to a light receiving element 10 that is the photodetector.

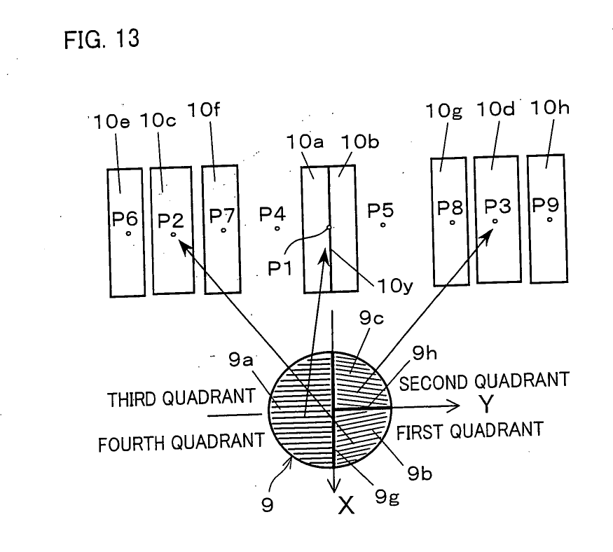

Here, as shown in FIG. 13, the hologram element 9 is divided into three division areas 9a, 9b, and 9c by (i) a dividing line 9g that extends in the x direction corresponding to the radial direction of the optical disc 6, and (ii) a dividing line 9h that extends in the y direction from the center of the dividing line 9g at right angle to the radial direction of the optical disc 6, that is, in a direction corresponding to the track direction of the optical disc 6. Different types of gratings are formed for respective division areas 9a, 9b and 9c.

The light receiving element 10 includes focusing two-part light receiving regions 10a and 10b, and tracking light receiving regions 10c, 10d, 10e, 10f, 10g and 10h.

A spot where the light from the beam deflection hologram is focused changes due to wavelength. By determining the size of the light receiving element 10 in consideration of the change, it is possible to realize a common receiving element with respect to different wavelengths.

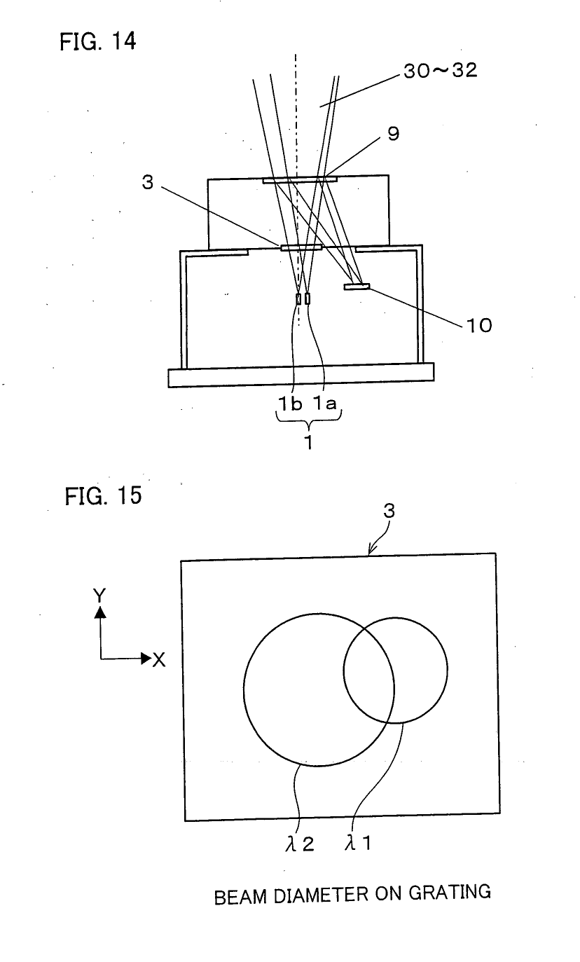

As shown in FIG. 14, (i) the light source 1 that is a light emitting element including the two-wavelength semiconductor lasers 1a and 1b, (ii) the grating 3 that is a light diffraction element, and (iii) a light detecting system including the hologram element 9 and the light receiving element 10, which system divides the reflected light by the dividing line 9h whose direction is substantially identical to the track direction of the optical disc 6 and then receives the light are integrated in one package.

When focused, as shown in FIG. 13, the main beam 30 diffracted in the division area 9a of the hologram element 9 forms a beam P1 on a division line 10y, and the main beam 30 diffracted in the division areas 9b and 9c forms beams P2 and P3 respectively in the tracking light receiving regions 10c and 10d.

Moreover, the ±1^{st} order sub beams 31 and 32 diffracted in the division area 9a respectively form beams P4 and P5 outside of the focusing two-part light receiving regions 10a and 10b, and the ±1^{st} order sub-beams 31 and 32 diffracted in the division areas 9b and 9c respectively form beams P6 and P7 in the tracking light receiving region 10e and 10f and beams P8 and P9 in the focusing light receiving regions 10g and 10h.

When the output signals of the focusing two-part light receiving regions 10a and 10b and the tracking light receiving regions 10c to 10h are Ia, Ib, Ic, Id, Ie, If, Ig and Ih, respectively, a focus error signal FES is calculated by a single knife edge method as follows.
(Ia−Ib)
A tracking error signal TES is calculated by the following equation.
TES=(Ic−Id)−k ((If−Ih)+((Ie−Ig))

In the equation of TES, (Ic−Id) is the push-pull signal of the main beam 30, and (If−Ih) and (Ie−Ig) are respectively the push-pull signals of the ±1^{st} order sub beams 31 and 32.

In the hologram laser unit, the grating 3 for three beams is provided at a position where the light beam is becoming wider. However, since positions of light emitting points of the two-wavelength semiconductor lasers 1a and 1b are different, the centers of the light beams having different wavelengths do not overlap on the grating 3 as shown in FIG. 3, unlike Embodiment 1. Note that the beam diameters shown in FIG. 15 are regions, contributing to the tracking signals, of the light beams of the first wavelength and the second wavelength, respectively.

A shift length on the grating 3 varies depending on a position of a light axis direction of the grating 3 and/or positions of the two-wavelength semiconductor lasers 1a and 1b. In the case in which the shift length is negligibly short with respect to the beam diameter, the grating patterns explained in Embodiment 1 can cause the light beams of respective wavelengths to have an appropriate phase shift. In the case in which the shift length is comparatively long, it is necessary to design a grating pattern in consideration of the shift length.

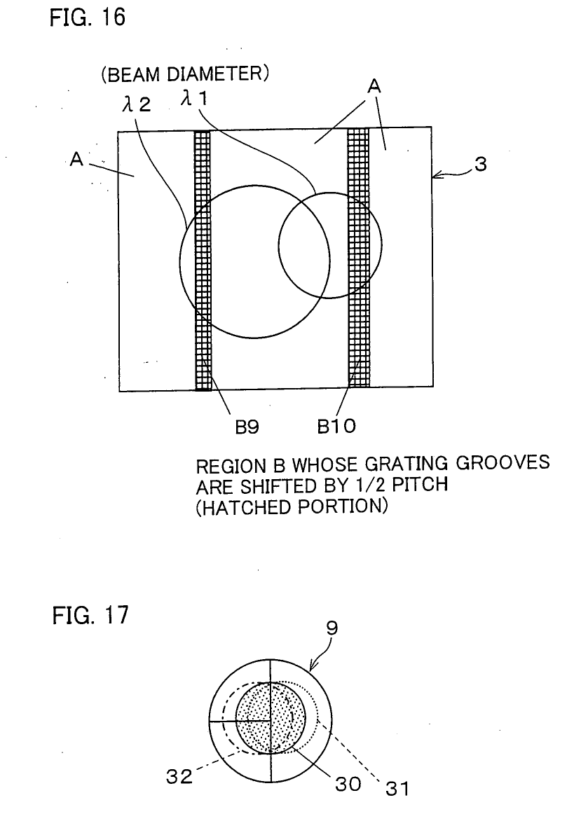

FIG. 16 shows a phase shift distribution in consideration of the above.

That is, a grating pattern of the present embodiment includes a plurality of regions A that are first grating patterns and a plurality of regions B that are second grating patterns. The regions B that are the second grating patterns are (i) a region B9 which is so set as to cause the light beam of a larger beam diameter to have an appropriate phase difference and (ii) a region B10 which is so set as to cause the light beam of a smaller beam diameter to have an appropriate phase difference. Moreover, the phase shift patterns (B9 and B10) are respectively formed in regions where the beam diameters used for recording and reproducing information do not overlap.

Moreover, the region B9 and the region B10 may be formed by a plurality of regions to be able to correspond to the disc 6 of a different push-pull pattern.

Moreover, the difference between Embodiment 1 and the present embodiment is that half light of the light beam, that is, light of only the division regions 9b and 9c of the hologram element 9 are used for detecting the push-pull signal PP.

In FIG. 13, for example, when the division areas 9b and 9c of the hologram element 9 receiving light of the return path are the first quadrant and the second quadrant, respectively, the push-pull signal amplitude needs to be cancelled out to 0 by the subtraction of only the optical outputs of the first and second-quadrants.

In the hologram laser unit, since the distance between the light source 1 and the grating 3 is short, the sub beams 31 and 32 actually incident on the objective lens 5 are portions of light that are shifted from the main beam 30 on the hologram 9, as shown in FIG. 17.

The shift length on the hologram element 9 changes depending on the positions in the light axis direction of the grating 3 and the hologram element 9. The shift length becomes comparatively a large value in an integrated compact hologram laser unit, or the like. In the case in which the shift length is negligibly short with respect to the beam diameter, the phase difference distribution is given to the center of the light axis, so that the same phase distribution is added to the +1^{st} order ray and the −1^{st} order ray. In the case in which the shift length is comparatively long, it is necessary to design an appropriate phase shift pattern.

The grating pattern, explained in the present embodiment, having the phase shift region(s) in the y direction is especially effective in the above case.

Thus, in the pickup apparatus of the present embodiment, the grating 3 is provided so that the region contributing to the tracking signal detection of the light beam having the wavelength λ1 and the region contributing to the tracking signal detection of the light beam having the wavelength λ2 overlap only partially or do not overlap.

With this, the region where the convexconcave pitches of the diffraction grooves are shifted from the pitches of other region(s) is in each of the regions through which the sub-beams 31 and 32 pass. Moreover, the pattern causing the phase shift is set so that the amplitudes of the push-pull signals of the sub-beams 31 and 32 of both of the light beams having different wavelengths are substantially cancelled. Therefore, the pattern can be set so that (i) in the case of irradiating the light beam having the wavelength λ1, the amplitudes of the push-pull signals of the sub-beams 31 and 32 are substantially cancelled only in the region through which the light beam having the wavelength λ1 passes, and (ii) in the case of irradiating the light beam having the wavelength λ2, the amplitudes of the push-pull signals of the sub-beams 31 and 32 are substantially cancelled only in the region through which the light beam having the wavelength λ2 passes.

As a result, regions where the light beam having the wavelength λ1 and the light beam having the wavelength λ2 do not overlap are formed. Therefore, the track detection using three beams can be carried out by using a single common grating with respect to the light beams having different wavelengths, and the offset component due to the lens shifting, etc can be cancelled easily.

Moreover, in the pickup apparatus of the present embodiment, a pattern causing the light beam having the wavelength λ1 to have the phase shift and a pattern causing the light beam having the wavelength λ2 to have the phase shift are formed within respective beam diameters so that the tracking signal detections have no interaction.

As a result, for example, as to an integrated pickup, such as a hologram laser unit, in which the two-wavelength semiconductor lasers 1a and 1b having different wavelengths are provided, even in the case in which the regions through which the light beams, emitted from the two-wavelength semiconductor lasers 1a and 1b, pass are shifted from each other on the grating 3, it is possible to suppress the amplitudes of the push-pull signals of the sub-beams 31 and 32.

Moreover, in the pickup apparatus of the present embodiment, the grating 3 is integrated in the integrated hologram laser unit. Therefore, in the integrated optical pickup of the integrated hologram laser unit having the two-wavelength semiconductor lasers 1a and 1b having different wavelengths, even in the case in which the regions through which the light beams, emitted from the two-wavelength semiconductor lasers 1a and 1b, pass are shifted from each other, it is possible to suppress the amplitudes of the push-pull signals of the sub-beams 31 and 32 by a combination of, for example, the grating 3 and the hologram element 9 of the integrated hologram laser unit.

(Embodiment 3)

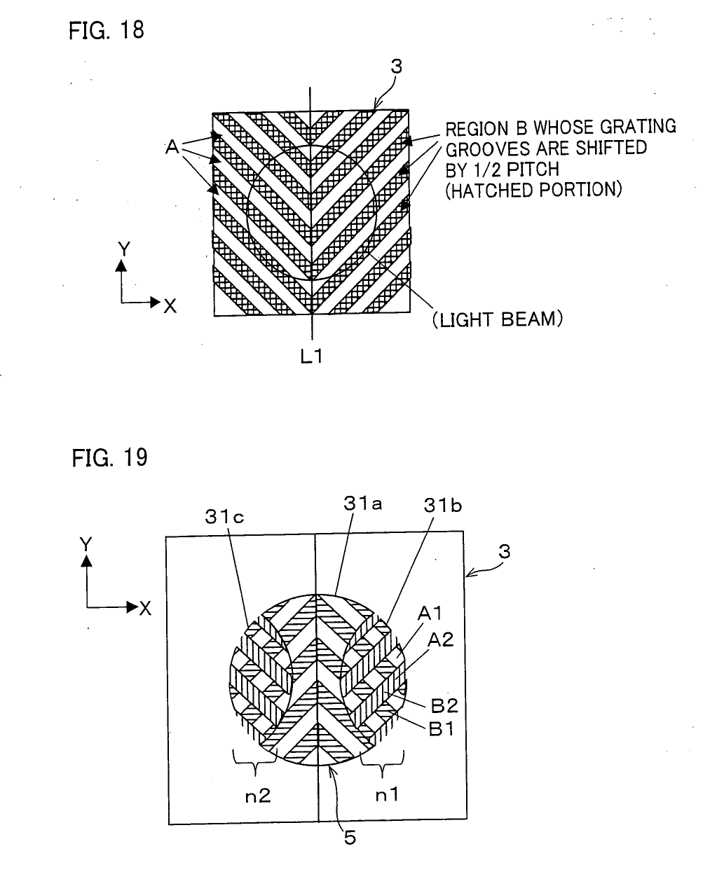

The following explains still another embodiment of the present invention in reference to FIGS. 18 to 22. Note that the members other than the members described in the present embodiment are the same with the members described in Embodiments 1 and 2. Therefore, for ease of explanation, the same reference numerals are used for the members having the same functions as the members shown in the figures of Embodiments 1 and 2, and further explanations thereof are omitted.

The arrangement of a pickup apparatus as an optical pickup of the present embodiment is the same as that of the pickup apparatus explained in Embodiment 2, but the pickup apparatus of the present embodiment is an improved version in which the accuracy of the phase difference given to the optical discs having different pitches and the accuracy of the phase difference with respect to the shifting of the grating 3 in the light axis direction are improved.

As described above, there are several types of CDs and DVDs as the optical disc 6. It is required to record and reproduce information to and from the optical discs having different standards with the same optical pickup apparatus.

The push-pull pattern changes depending on, for example, the pitch of the optical disc 6 and -the magnification of the optical system of the optical pickup apparatus, so that the phase shift pattern of the grating 3 needs to be optimally designed in consideration of these.

In the case of the pattern, explained in Embodiment 1, having a plurality of the phase shift regions parallel to the y axis, it is possible to produce the grating 3 corresponding to two or three types of the optical discs 6 by optimally designing. the pattern. However, the characteristics of the track detection change in the case in which, for example, an optical parameter(s) of the pickup apparatus including the grating 3 changes.

A method for solving the problems is the phase shift pattern shown in FIG. 18. FIG. 19 shows the push-pull pattern of the sub-beams 31 and 31 when using the phase shift pattern shown in FIG. 18. The 0 order diffraction ray and the +1^{st} order diffraction ray of the sub-beam 31 interfere in the push-pull signal region n1, and as shown in FIG. 19, a plurality of regions having different phases appears in the push-pull signal region n1.

In a region A2, the region where the phase is shifted by 180 degrees in the 0 order diffraction ray and the region where the phase is shifted by 180 degrees in the 1^{st} order diffraction ray overlap, and the phase of the amplitude of the push-pull signal is the same as the phase of the amplitude of the push-pull signal of a region A1 where the region of no phase shift in the 0 order diffraction ray and the region of no phase shift in the 1^{st} order diffraction ray overlap.

Meanwhile, in a region B1, the region where the phase is shifted in the 0 order diffraction ray and the region of no phase shift in the +1^{st} order diffraction ray overlap, and in a region B2, the region where the phase is shifted in the +1^{st} order diffraction ray and the region of no phase shift in the 0 order diffraction ray overlap. Therefore, the phases of the amplitudes of the push-pull signals of the regions B1 and B2 are opposite to the phases of the amplitudes of the push-pull signals of the regions A1 and A2.

Because the region A and the region B, whose phases of the amplitudes of the push-pull signals are opposite to each other, are substantially equal in area, the amplitude of the push-pull signal in the push-pull signal region n1 is substantially 0.

However, the pattern shown in FIG. 19 is designed only for one type of wavelength. Therefore, unlike the pickup apparatus explained in Embodiment 2, it is impossible to give an appropriate phase shift pattern by the pattern shown in FIG. 19 in the case in which the light beams emitted from the two-wavelength semiconductor lasers 1a and 1b are shifted from each other on the grating 3. The pickup apparatus of the present embodiment gives an effective phase shift pattern in such a case.

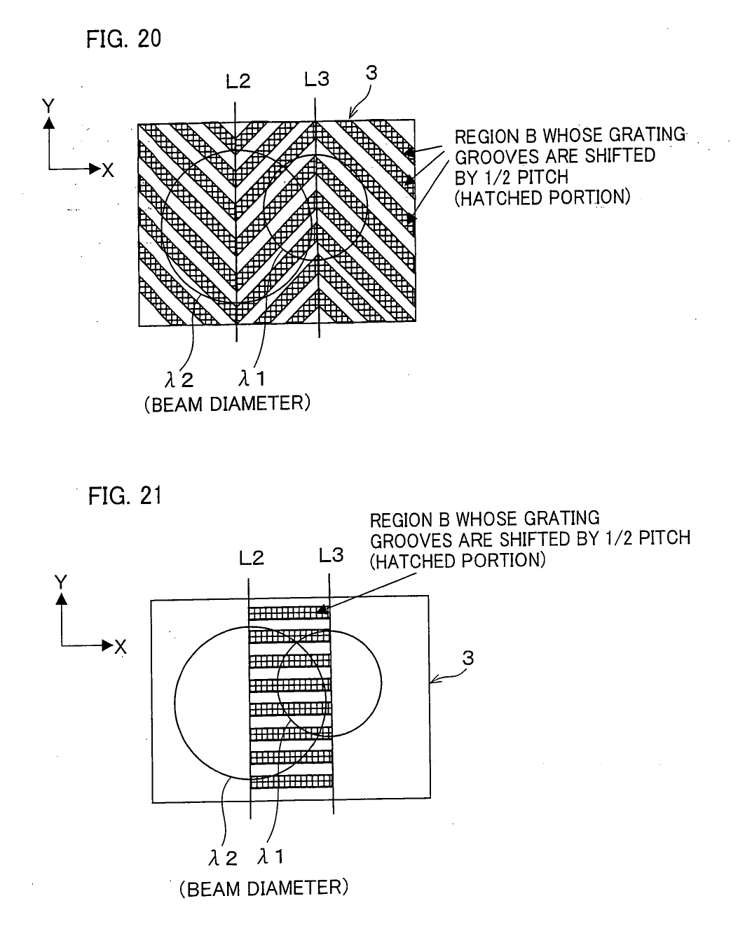

As shown in FIG. 20, the grating pattern of the present embodiment is characterized in that the regions A that are the first grating patterns and the regions B that are the second grating patterns are alternately provided at even intervals, that is, form a striped phase shift pattern, and change their shapes at straight lines L2 and L3 which passes through the centers of the light beams, respectively, and are parallel to the y axis.

In the case of using the pattern shown in FIG. 20, phase shift regions similar to the phase shift regions shown in FIG. 19 appear in the push-pull pattern of the sub-beams 31 and 32 of the light beams of the wavelengths λ1 and λ2, the centers of the light beams being shifted from each other. Therefore, the amplitudes of the push-pull signals of the sub-beams 31 and 32 can be 0.

Moreover, even in the cases in which (i) the optical discs having different pitches are used, (ii) the optical parameter(s) of the pickup apparatus is changed, such as the magnification of the optical system, etc., and (iii) the beam diameter is changed due to the positioning of the grating 3, the same patterns shown in FIG. 20 appear. Therefore, the characteristic of the track detection do not change so much. On this account, it is possible to improve versatility and mass productivity of the pickup apparatus.

Moreover, in the case in which the width of the phase shift is narrower, an error in area of the regions where the phases are different from each other in the push-pull signal regions n1 and n2 becomes small. Therefore, the characteristics of the track detection further improve.

Moreover, in the present embodiment, the phase shift pattern between the straight lines L2 and L3 that are boundaries and the phase shift pattern in the other regions have only to be different from each other. One example of such phase shift pattern is shown in FIG. 21. In this grating 3, the phase shift pattern is formed only in an area between the straight lines L2 and L3 that are the boundaries.

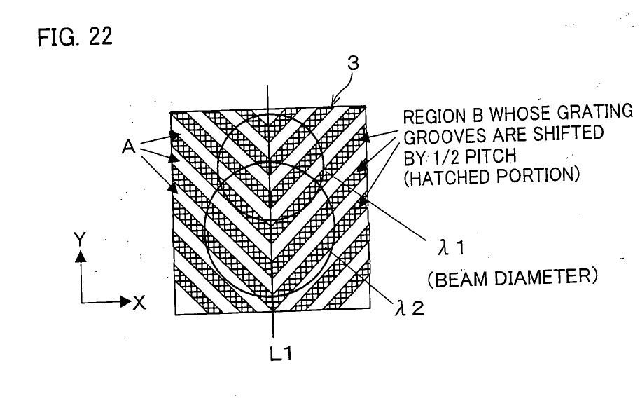

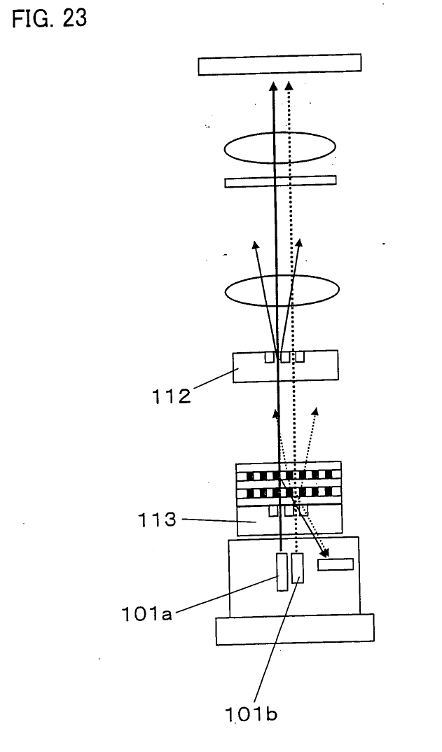

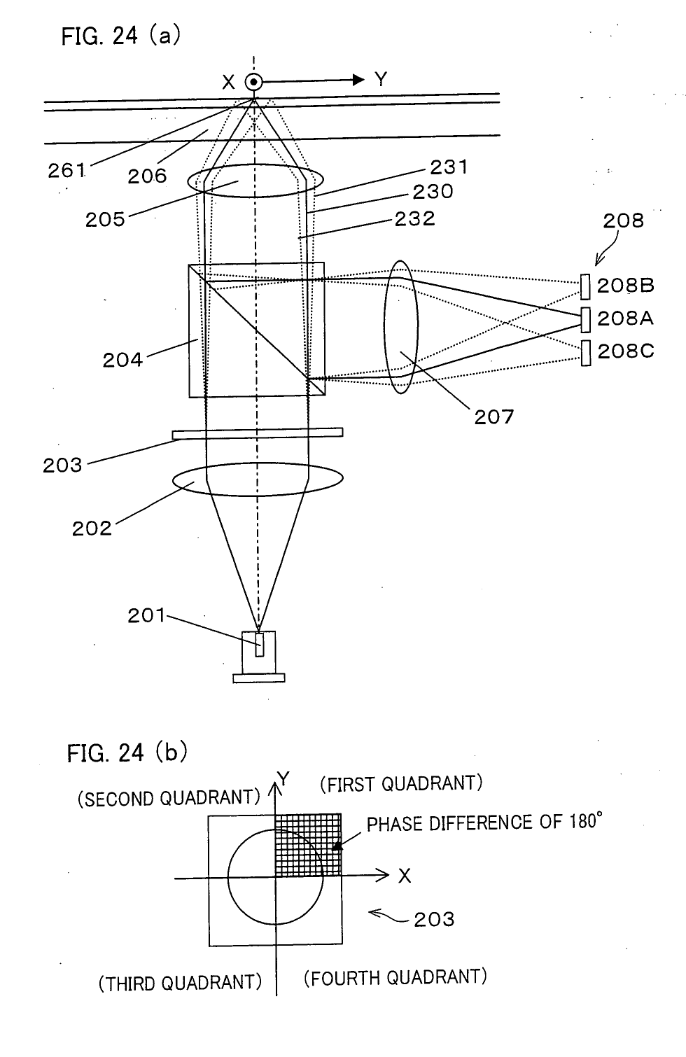

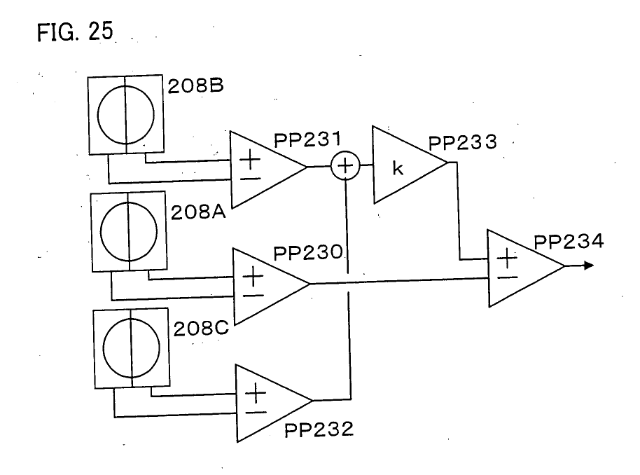

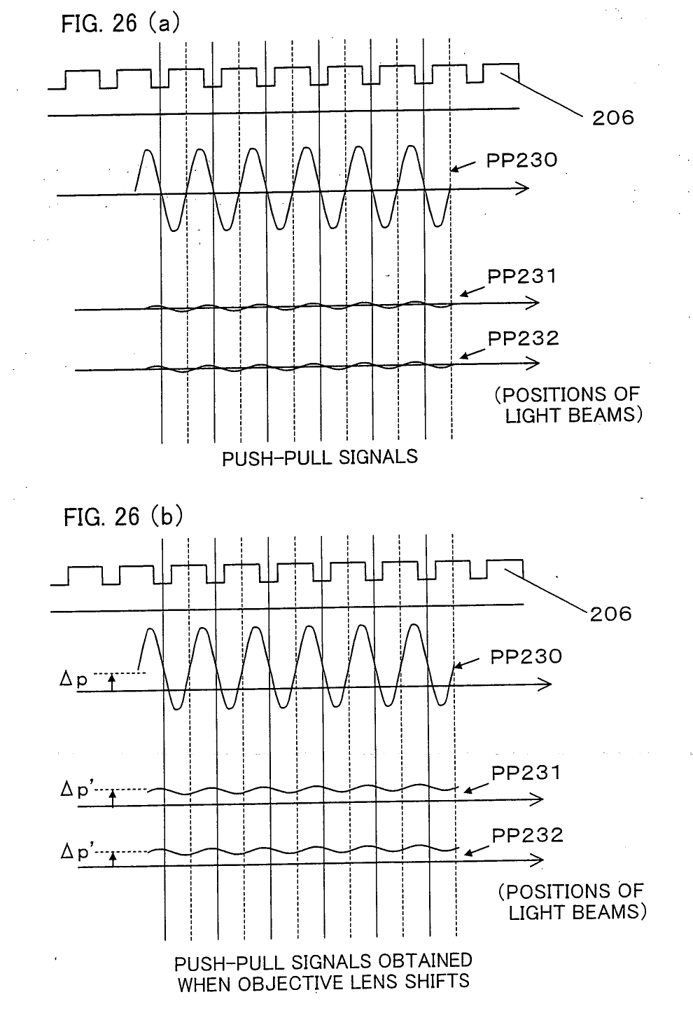

Moreover, in the case in which the two-wavelength semiconductor lasers 1a and 1b having different wavelength are so provided that, as shown in FIG. 22, the centers of the light beams emitted from the two-wavelength semiconductor lasers 1a and 1b provided at different positions pass through the same straight line as the straight line L1 which passes through the center of the grating 3 and is parallel to the y axis, the push-pull pattern of the sub-beams 31 and 32 of the light beams of the wavelengths λ1 and λ2 becomes the same pattern as the pattern shown in FIG. 19, by the pattern of the grating 3 shown in FIG. 18. Therefore, in the case of the positioning of the two-wavelength semiconductor lasers 1a and 1b, the displacement of the two-wavelength semiconductor lasers 1a and 1b can be recovered by the grating 3.

Thus, in the pickup apparatus of the present embodiment, a pattern causing a phase shift between a first boundary and a second boundary is different from a pattern of other region(s) on the grating 3, the first boundary passing through substantially a center of the light beam having the wavelength λ1 and being substantially parallel to a track direction of the optical disc 6, and the second boundary passing through substantially a center of the light beam having the wavelength λ2 and being substantially parallel to the track direction of the optical disc.

Thus, the left half of the region through which the light beam having the wavelength λ1 passes and the right half of the region through which the light beam having the wavelength λ2 passes do not overlap. Therefore, by securing (i) the pattern, causing the sub-beams 31 and 32 to have the phase shift, in the region through which the light beam having the wavelength λ1 passes and (ii) the pattern, causing the sub-beams 31 and 32 to have the phase shift, in the region through which the light beam having. the wavelength λ2 passes, it is possible to suppress the amplitudes of the push-pull signals of the sub-beams 31 and 32.

As a result, it is possible to suppress the amplitudes of the push-pull signals of the sub-beams 31 and 32 even in the cases in which: the optical discs having different standards are used; the optical parameter(s) of the pickup apparatus is changed; the grating 3 is shifted in the light axis direction due to the assembling error; the tracking error signal (TES) is detected by part of the light beam; etc.

Moreover, in the pickup apparatus of the present embodiment, the pattern causing the sub-beams 31 and 32 to have the phase shift and the pattern for not causing the sub-beams 31 and 32 to have the phase shift are alternately provided at even intervals. Therefore, the patterns can be set as follows: in the region through which each sub-beam 31 or 32 passes, (i) in the case of irradiating the light beam having the wavelength λ1, the amplitudes of the push-pull signals of the sub-beams 31 and 32 are substantially cancelled only in the region through which the light beam having the wavelength λ1 passes, and (ii) in the case of irradiating the light beam having the wavelength λ2, the amplitudes of the push-pull signals of the sub-beams 31 and 32 are substantially cancelled only in the region through which the light beam having the wavelength λ2 passes.

On this account, the region where the convexconcave pitches are shifted from the pitches of other regions can be surely secured in the regions where the light beam having the wavelength λ1 and the light beam having the wavelength λ2 do not overlap. Therefore, it is possible to suppress the amplitudes of the push-pull signals of the sub-beams 31 and 32.

Especially, the same patterns are formed even in the cases in which: the optical discs 6 having different standards are used; the optical parameter(s) of the pickup apparatus is changed; the grating 3 is shifted in the light axis direction due to the assembling error; the tracking error signal (TES) is detected by part of the light beam; etc. Therefore, the characteristics of the track detection do not change so much, and it is possible to suppress the amplitudes of the push-pull signals of the sub-beams 31 and 32.

Moreover, in the pickup apparatus of the present embodiment, the first grating pattern and the second grating pattern are formed only between the straight line L2 that is the first boundary and the straight line L3 that is the second boundary. Even in this case, in each region through which the sub-beam 31 passes and the sub-beam 32 passes, the region where the convexconcave pitches are shifted from the pitches of other region(s) can be surely secured in the regions where the light beam having the wavelength λ1 and the light beam having the wavelength λ2 do not overlap. Therefore, it is possible to suppress the amplitudes of the push-pull signals of the sub-beams 31 and 32.

Because the pattern causing the phase shift have only to be formed only in the area between the straight line L2 and the straight line L3, it is possible to simplify the assembling process and reduce the cost of the pickup apparatus.

Moreover, in the pickup apparatus of the present embodiment, the straight lines L2 and L3 can be identical to each other, that is, the straight lines L2 and L3 can be a single straight line L1. On this account, in the case in which the two-wavelength semiconductor lasers 1a and 1b having different wavelengths are so provided that the centers of the light beams emitted from the two-wavelength semiconductor lasers 1a and 1b provided at different positions pass through the same straight line as a straight line which passes through the center of the grating 3 and is parallel to the y axis, it is possible to suppress the amplitudes of the push-pull signals of the sub-beams. As above, in the optical pickup of the present invention, (i) the first region is inside the second region on the grating, the first and second regions contributing to a tracking signal detection, (ii) the pattern causing the partial phase shift includes a first phase shift pattern and a second phase shift pattern which are formed parallel to a track, (iii) the first phase shift pattern is provided so as to include part of the first region and part of the second region, and (iv) the second phase shift pattern is provided so as to include only part of the second region.

According to the above invention, (i) the pattern causing the partial phase shift includes the first phase shift pattern and the second phase shift pattern which are formed parallel to the track, (ii) the first phase shift pattern is provided so as to include part of the first region and part of the second region, and (iii) the second phase shift pattern is provided so as to include only part of the second region.

That is, the pattern causing the phase shift is arranged as above in the case in which the region through which the light beam of the first wavelength passes is inside the region through which the light beam of the second wavelength passes, on the grating, the regions contributing to the tracking signal detection.

As a result, in the track detection by using the phase shift DPP method and the optical pickup in which a plurality of light sources having different wavelengths are integrated in one package, it is possible to surely suppress the amplitudes of the push-pull signals of the sub-beams even in the case of using different numerical apertures depending on the wavelength or in the case in which the light beams having different standards are used.

Moreover, in the optical pickup of the present invention, in addition to the above optical pickup, a pattern causing the light beam having the first wavelength to have the phase shift and a pattern causing the light beam having the second wavelength to have the phase shift are formed on one side of a boundary which passes through centers of the light beams passing through the grating and is substantially parallel to a track direction of the optical disc.

According to the above invention, on the grating, the pattern causing the light beam having the first wavelength to have the phase shift and the pattern causing the light beam having the second wavelength to have the phase shift are formed on one side of a boundary which passes through the centers of the light beams passing through the grating and is substantially parallel to the track direction of the optical disc.

Because the patterns causing the light beams of the first and the second wavelengths to have the phase shift are formed on one side of the grating, it is possible to simplify the assembling process and reduce the cost of the optical pickup.

Moreover, in the optical pickup of the present invention, in addition to the above optical pickup, a pattern causing the light beam having the first wavelength to have the phase shift is formed on one side of a boundary which passes through centers of the light beams passing through the grating and is substantially parallel to a track direction of the optical disc, and a pattern causing the light beam having the second wavelength to have the phase shift is formed on both sides of the boundary which passes through the centers of the light beams passing through the grating and is substantially parallel to the track direction of the optical disc.

According to the above invention, the pattern causing the light beam having the first wavelength to have the phase shift is formed on one side of the boundary which passes through the center of the light beam passing through the grating and is substantially parallel to the track direction of the optical disc, and the pattern causing the light beam having the second wavelength to have the phase shift is formed on both sides of the boundary which passes through the center of the light beam passing through the grating and is substantially parallel to the track direction of the optical disc.

Therefore, for example, in the case of using the optical disc 6 having wide track pitches or in the case in which the regions, contributing to the tracking signal detection, through which regions the light beams of the wavelengths λ1 and λ2 pass substantially overlap, the pattern causing the light beams having the first and second wavelengths to have the phase shift is formed on both sides of the grating, as explained in the present invention. In this way, it is possible to surely suppress the amplitudes of the push-pull signals of the sub-beams.

Moreover, in the optical pickup of the present invention, in addition to the above optical pickup, the grating is provided so that a region contributing to a tracking signal detection of the light beam having the first wavelength and a region contributing to the tracking signal detection of the light beam of the second wavelength overlap only partially or do not overlap.

According to the above invention, the grating is provided so that the region contributing to the tracking signal detection of the light beam of the first wavelength and the region contributing to the track signal detection of the light beam of the second wavelength overlap only partially or do not overlap.

Thus, the grating has a region having the convexconcave pitches of diffraction grooves, the pitches being shifted from pitches of other region(s) of the grating, and the pattern causing the phase shift is set so that amplitudes of push-pull signals of the sub-beams are substantially cancelled in each of the light beams having different wavelengths. With this, the pattern can be set so that, in the case of irradiating the light beam having the first wavelength, the amplitudes of the push-pull signals of the sub-beams are substantially cancelled only in the region through which the light beam having the first wavelength passes. Moreover, the pattern can be set so that, in the case of irradiating the light beam having the second wavelength, the amplitudes of the push-pull signals of the sub-beams are substantially cancelled only in the region through which the light beam having the second wavelength passes.

Therefore, the track detection using three beams can be carried out by using a single common grating with respect to the light beams having different wavelengths, and the offset component due to the lens shifting, etc. can be cancelled easily.

Moreover, in the optical pickup of the present invention, in addition to the above optical pickup, a pattern causing the light beam having the first wavelength to have the phase shift and a pattern causing the light beam having the second wavelength to have the phase shift are formed within respective beam diameters so that the tracking signal detections have no interaction.

According to the above invention, the pattern causing the light beam having the first wavelength to have the phase shift and the pattern causing the light beam having the second wavelength to have the phase shift are formed within respective beam diameters so that the tracking signal detections have no interaction.

As a result, for example, as to an integrated pickup, such as a hologram laser unit, in which the light sources having different wavelengths are provided, even in the case in which the regions through which the light beams, emitted from the light sources, pass are shifted from each other on the grating, it is possible to suppress the amplitudes of the push-pull signals of the sub-beams.

Moreover, in the optical pickup of the present invention, in addition to the above optical pickup, a pattern. causing a phase shift between a first boundary and a second boundary is different from a pattern of other region(s) on the grating, the first boundary passing through substantially a center of the light beam having the first wavelength and being substantially parallel to a track direction of the optical disc, and the second boundary passing through substantially a center of the light beam having the second wavelength and being substantially parallel to the track direction of the optical disc.

According to the above invention, the left half of the region through which the light beam having the first wavelength passes and the right half of the region through which the light beam having the second wavelength passes do not overlap. Therefore, by securing (i) the pattern, causing the sub-beams to have the phase shift, in the region through which the light beam having the first wavelength passes and (ii) the pattern, causing the sub-beams to have the phase shift, in the region through which the light beam having the second wavelength passes, it is possible to suppress the amplitudes of the push-pull signals of the sub-beams.

As a result, it is possible to suppress the amplitudes of the push-pull signals of the sub-beams even in the cases in which: the optical discs having different standards are used; the optical parameter(s) of the pickup apparatus is changed; the grating is shifted in the light axis direction due to the assembling error; the tracking error signal (TES) is detected by part of the light beam; etc.

Moreover, in the optical pickup of the present invention, in addition to the above optical pickup, a first grating pattern and a second grating pattern are alternately provided at even intervals on the grating, the first grating pattern having convexconcave substantially perpendicular to the track direction of the optical disc, and the second grating pattern having convexconcave which are shifted from the convexconcave of the first grating pattern.

According to the above invention, the pattern causing the sub-beams to have the phase shift and the pattern for not causing the sub-beams to have the phase shift are alternately provided at even intervals. Therefore, the patterns can be set as follows: in each region through which each sub-beam passes, (i) in the case of irradiating the light beam having the first wavelength, the amplitudes of the push-pull signals of the sub-beams are substantially cancelled only in the region through which the light beam having the first wavelength passes, and (ii) in the case of irradiating the light beam having the second wavelength, the amplitudes of the push-pull signals of the sub-beams are substantially cancelled only in the region through which the light beam having the second wavelength passes.

On this account, it is possible to surely secure a region where the convexconcave pitches are shifted from the pitches of other region(s). Therefore, it is possible to suppress the amplitudes of the push-pull signals of the sub-beams.

Especially, the same patterns are formed even in the cases in which: the optical discs having different standards are used; the optical parameter(s) of the optical pickup is changed; the grating is shifted in the light axis direction due to the assembling error; the tracking error signal (TES) is detected by part of the light beam; etc. Therefore, the characteristics of the track detection do not change so much, and it is possible to suppress the amplitudes of the push-pull signals of the sub-beams.

Moreover, in the optical pickup of the present invention, in addition to the above optical pickup, the first grating pattern and the second grating pattern are formed only between the first boundary and the second boundary.

According to the above invention, the first grating pattern and the second grating pattern are formed only in the area between the first boundary and the second boundary. Even in this case, in each region through which each sub-beam passes, the region where the convexconcave pitches are shifted from the pitches of other region(s) can be surely secured in the regions where the light beam having the first wavelength and the light beam having the second wavelength do not overlap. Therefore, it is possible to suppress the amplitudes of the push-pull signals of the sub-beams.

Because the pattern causing the phase shift have only to be formed only in the area between the first boundary and the second boundary, it is possible to simplify the assembling process and reduce the cost of the optical pickup.

Moreover, in the optical pickup of the present invention, in addition to the above optical pickup, the first boundary and the second boundary are identical to each other.

According to the above invention, the first boundary and the second boundary are identical to each other. On this account, in the case in which the centers of the light beams emitted from the light sources provided at different positions passes through the same straight line as a straight line which passes through the center of the grating and is parallel to the y axis, it is possible to suppress the amplitudes of the push-pull signals of the sub-beams.

Moreover, in the optical pickup of the present invention, in addition to the above optical pickup, the grating is integrated in an integrated hologram laser unit.

According to the above invention, the grating is integrated in the integrated hologram laser unit. Therefore, in the integrated optical pickup of the integrated hologram laser unit having a plurality of light sources having different wavelengths, even in the case in which the regions through which the light beams, emitted from the light. sources, pass are shifted from each other, it is possible to suppress the amplitudes of the push-pull signals of the sub-beams by a combination of, for example, the grating and the hologram element of the integrated hologram laser unit.

The present invention is not limited to the embodiments above, but may be altered within the scope of the claims. An embodiment based upon a proper combination of technical means disclosed in different embodiments is encompassed in the technical scope of the present invention.

### INDUSTRIAL APPLICABILITY

The present invention is applicable to an optical pickup which optically records and reproduces information to and from an information recording medium, such as an optical disc.

1. An optical pickup which carries out tracking by three beams with respect to an optical disc, the optical pickup comprising:
a one-packaged light source for emitting a light beam having a first wavelength and a light beam having a second wavelength;
a grating for splitting a light beam, emitted from the one-packaged light source, into a main beam and two sub-beams;
an objective lens for focusing the main beam and the sub-beams on the optical disc; and
a photodetector for detecting push-pull signals from respective light, of the main beam and the sub-beams, reflected by the optical disc,
the grating including first and second regions through which the light beams, having first and second wavelengths, respectively, pass, each of the regions including a region having diffraction grooves whose concavoconvex pitches are partially shifted so that a pattern is provided to cause each of the first and second light beams to have a partial phase shift, and
the pattern being set so that amplitudes of the push-pull signals of the sub-beams are substantially cancelled in each of the light beams having different wavelengths.

2. The optical pickup as set forth in claim 1, wherein:
the first region is inside the second region on the grating, the first and second regions contributing to a tracking signal detection;
the pattern causing the partial phase shift includes a first phase shift pattern and a second phase shift pattern which are formed substantially parallel to a track;
the first phase shift pattern is provided so as to include part of the first region and part of the second region; and
the second phase shift pattern is provided so as to include only part of the second region.

3. The optical pickup as set forth in claim 2, wherein a pattern causing the light beam having the first wavelength to have the phase shift and a pattern causing the light beam having the second wavelength to have the phase shift are formed on one side of a boundary which passes through centers of the light beams passing through the grating and is substantially parallel to a track direction of the optical disc.

4. The optical pickup as set forth in claim 2, wherein:
a pattern causing the light beam having the first wavelength to have the phase shift is formed on one side of a boundary which passes through centers of the light beams passing through the grating and is substantially parallel to a track direction of the optical disc; and
a pattern causing the light beam having the second wavelength to have the phase shift is formed on both sides of the boundary which passes through the centers of the light beams passing through the grating and is substantially parallel to the track direction of the optical disc.

5. The optical pickup as set forth in claim 1, wherein the grating is provided so that a region contributing to a tracking signal detection of the light beam having the first wavelength and a region contributing to a tracking signal detection of the light beam having the second wavelength overlap only partially or do not overlap.

6. The optical pickup as set forth in claim 5, wherein a pattern causing the light beam having the first wavelength to have the phase shift and a pattern causing the light beam having the second wavelength to have the phase shift are formed within respective beam diameters so that the tracking signal detections have no interaction.

7. The optical pickup as set forth in claim 5, wherein a pattern causing a phase shift between a first boundary and a second boundary is different from a pattern of other region(s) on the grating, the first boundary passing through substantially a center of the light beam having the first wavelength and being substantially parallel to a track direction of the optical disc, and the second boundary passing through substantially a center of the light beam having the second wavelength and being substantially parallel to the track direction of the optical disc.

8. The optical pickup as set forth in claim 7, wherein a first grating pattern and a second grating pattern are alternately provided at even intervals on the grating, the first grating pattern having convexoconcave substantially perpendicular to the track direction of the optical disc, and the second grating pattern having convexoconcave which are shifted from the convexoconcave of the first grating pattern.

9. The optical pickup as set forth in claim 7, wherein a first grating pattern and a second grating pattern are formed only between the. first boundary and the second boundary.

10. The optical pickup as set forth in claim 7, wherein the first boundary and the second boundary are identical to each other.

11. The optical pickup as set forth in any one of claims 2 to 10, wherein the grating is integrated in an integrated hologram laser unit.
